(19) United States
(12) Patent Application Publication
(10) Pub. No.: US 2008/0131728 A1
(43) Pub. Date: Jun. 5, 2008

(54) ACIDIC ZINCATING SOLUTION

(76) Inventors: Manesh Nadupparambil Sekharan, Troy, MI (US); Bashir M. Ahmed, Rochester, MI (US); Omar L. Abu-Shanab, Auburn Hills, MI (US); William E. Fristad, Rochester Hills, MI (US); Brian J. Marvin, Warren, MI (US)

Correspondence Address: HENKEL CORPORATION, 1001 TROUT BROOK CROSSING, ROCKY HILL, CT, 06067, US

(21) Appl. No.: 11/948,689

(22) Filed: Nov. 30, 2007

Related U.S. Application Data
(60) Provisional application No. 60/868,141, filed on Dec. 1, 2006.

(51) Int. Cl. B05D 1/18; C09D 5/00; B32B 15/01

(52) U.S. Cl. 428/650; 106/1.29; 427/436

(57) ABSTRACT

An aqueous, acidic zincating composition comprising: zinc cations; fluoride anions; and a carboxylic acid having at least one additional —OH substituent is provided that is useful in a process of making a corrosion resistant article comprising contacting an article having an aluminum surface with the zincating composition and thereafter coating the article with an autodeposition coating.

### CROSS-REFERENCE TO RELATED CASES

This application claims priority to U.S. Provisional Patent Application Ser. No. 60/868,141 filed Dec. 1, 2006, hereby incorporated herein by reference.

### FIELD OF THE INVENTION

This invention relates to a method of treating metal articles to protect them against corrosion by a two step process and an acidic zincating composition used in the process. In particular, it is directed to a process for applying a coating of metallic zinc on aluminum surfaces of a metal article, known as “zincating”, and thereafter depositing a polymeric coating, in particular an autodeposition coating, to protect the article against corrosion. The invention also relates to articles of manufacture made according to this process.

### BACKGROUND OF THE INVENTION

The term “zincating” as used herein describes a process of coating metal substrates especially aluminum and its alloys with zinc metal. Conventional zincating solution is strongly alkaline and often made up from zinc oxide and sodium hydroxide solution. Typical conditions of known processes for the zincating of aluminum consists of immersing the clean aluminum surface into a bath containing about 13 ounces per gallon of zinc oxide and about 70 ounces per gallon of sodium hydroxide for 30 seconds to one minute at a bath temperature of around 70-90° F. In another conventional zincating treatment, a bath containing 300-500 g/l NaOH and 50-100 g/1 dissolved ZnO at a temperature of 20-30° C. is used. The layer of metallic zinc on an aluminum surface resulting from alkaline zincating baths is generally on the order of 0.00015-0.0002 inch thickness. One drawback of thick zinc metal coatings is reduced adherence and uniformity of the coating. Another drawback is embrittlement of the zinc metal coating which can result in cracking upon bending and loss of adhesion of both the zinc coating and subsequently applied polymeric coatings, such as autodeposited coatings.

Autodeposition coatings, which are adherent coatings formed on metal surfaces, comprise an organic polymer coating deposited by electroless chemical reaction of the coating bath with the metal surfaces. Autodeposition has been in commercial use on steel for about thirty years and is now well established for that use. For details, see for example, U.S. Pat. No. 3,592,699 (Steinbrecher et al.); U.S. Pat. Nos. 4,108,817 and 4,178,400 (both to Lochel); U.S. Pat. No. 4,180,603 (Howell. Jr.); U.S. Pat. Nos. 4,242,379 and 4,243,704 (both to Hall et al.); U.S. Pat. No. 4,289,826 (Howell, Jr.); and U.S. Pat. No. 5,342,694 (Ahmed) as well as U.S. Pat. No. 5,500,460 (Ahmed et al.). The disclosures of all of these patents are hereby incorporated by reference.

Autodeposition compositions are usually in the form of liquid, usually aqueous, solutions, emulsions or dispersions in which active metal surfaces of inserted objects are coated with an adherent resin or polymer film that increases in thickness the longer the metal object remains in the bath, even though the liquid is stable for a long time against spontaneous precipitation or flocculation of any resin or polymer, in the absence of contact with active metal. “Active metal” is defined as metal that is more active than hydrogen in the electromotive series, i.e., that spontaneously begins to dissolve at a substantial rate (with accompanying evolution of hydrogen gas) when introduced into the liquid solution, emulsion or dispersion. Such compositions, and processes of forming a coating on a metal surface using such compositions, are commonly denoted in the art, and in this specification, as “autodeposition” or “autodepositing” compositions, dispersions, emulsions, suspensions, baths, solutions, processes, methods, or a like term. Autodeposition is often contrasted with electrodeposition, which can produce similar adherent films but requires that metal or other objects to be coated be connected to a source of direct current electricity for coating to occur. No such external electric current is used in autodeposition. Additional compositions and processes for depositing autodeposited coatings are described in U.S. Pat. No. 6,989,411; 6,645,633; 6,559,204; 6,096,806; and 5,300,323, incorporated herein by reference.

Despite excellent qualities of these known autodeposited coatings on ferrous metals and zinciferous metals, a drawback has been pinhole formation in the coatings deposited on aluminum and aluminum alloy surfaces. Without being bound by a single theory, it is believed that the pinholes are formed when aluminum reacts with the autodeposition bath constituents. These “pinholes” are unsightly and serve as corrosion initiation points where the autodeposition coating is thinner or missing. Thus there is a need for a solution to the problem of pinhole formation in autodeposited coatings deposited on aluminum and aluminum alloy surfaces.

### SUMMARY OF THE INVENTION

This invention provides a solution to pinhole formation in autodeposition coatings deposited on aluminum surfaces through the use of an aqueous acidic zincating composition and process for zincating using the composition prior to autodeposition coating. The aqueous acidic zincating composition is useful in manufacture of corrosion resistant articles by applying a zinc metal coating by aqueous acidic zincating and subsequently applying a corrosion resistant polymeric coating, e.g. an autodeposited coating, to the zincated article. The term “aluminum” as used herein refers to aluminum metal and alloys thereof.

One object of the invention is to provide an article of manufacture comprising: (a) a substrate comprising aluminum or an aluminum alloy; (b) a shielding layer provided on the substrate, the shielding layer comprising, preferably consisting essentially of, most preferably consisting of metallic zinc; and (c) a corrosion resistant layer on the shielding layer, the corrosion resistant layer comprising an autodeposited coating, preferably comprising an organic component selected from polymers and copolymers of acrylic, polyvinyl chloride, epoxy, polyurethane and mixtures thereof, most preferably an epoxy-acrylic hybrid. The substrate desirably comprises a core layer and a clad layer formed of aluminum or an aluminum alloy, and wherein the shielding layer is disposed on the clad layer. The core layer is generally comprised of metal, desirably a ferriferous or light metal, such as by way of non-limiting example steel, iron, aluminum, magnesium, titanium and mixtures thereof. The clad layer may be aluminum or an aluminum alloy, desirably the alloy comprises at least 35% aluminum. In one embodiment the aluminum alloy contains aluminum and one or more alloying elements selected from silicon, magnesium, zinc and manganese.

Another object of the invention is to provide an article of manufacture comprising: (a) a metal substrate comprising an aluminum or aluminum alloy surface; (b) a shielding layer deposited on the aluminum or aluminum alloy surface, the shielding layer comprising, preferably consisting essentially of, most preferably consisting of metallic zinc, optionally the shielding layer includes an amount of aluminum that has a maximum concentration near the aluminum surface and a minimum concentration of zero in portions of the shielding layer farthest from the aluminum surface; and (c) a corrosion resistant layer deposited on and adhering to the shielding layer, the corrosion resistant layer comprising an autodeposited coating, preferably comprising an organic component selected from polymers and copolymers of acrylic, polyvinyl chloride, epoxy, polyurethane and mixtures thereof, most preferably an epoxy- acrylic hybrid polymer.

The invention includes articles of manufacture having a homogeneous metallic composition, such as aluminum and aluminum alloy articles. The invention also includes articles of manufacture having a heterogeneous metallic composition, such as articles having portions or parts of dissimilar metals wherein at least one of the portions or parts comprises an aluminum surface, for example an article comprised of a part having steel surfaces attached to a part having aluminum surfaces or an article comprising a first galvanized steel portion and a second aluminum alloy portion, and the like.

It is another object of the invention to provide an aqueous zincating bath useful in producing a layer of metallic zinc on an aluminum surface, which in one embodiment comprises:
a) At least 50 wt % water;
b) zinc cations
c) fluoride anions;
d) an inorganic acid, preferably HF;
e) a C₂-C₁₀ mono-carboxylic acid having at least one additional —OH substituent; and
f) optionally, ferric sulfate.

It is also an object of the invention to provide a process for coating an article comprising a substrate having at least one aluminum surface comprising:
a) depositing a metallic zinc coating on the aluminum surface by contacting the aluminum surface with an acidic aqueous zincating bath as described herein;
b) rinsing with water, preferably deionized water;
c) contacting the metallic zinc coated aluminum surface with an autodeposition bath, preferably comprising an organic component selected from polymers and copolymers of acrylic, polyvinyl chloride, epoxy, polyurethane and mixtures thereof, most preferably an epoxy-acrylic hybrid, for a sufficient time and at a sufficient temperature to deposit an uncured autodeposition coating thereon;
d) rinsing with water, preferably deionized water;
e) optionally, contacting the uncured autodeposition coating with an alkaline or acidic rinse; and
f) curing the uncured autodeposition coating.

It is a further object of the invention to provide a process and articles of manufacture wherein the metallic zinc coating deposited has a thickness of about 30 to about 120 mg/ft².

It is a further object of the invention to provide a process wherein the temperature of the zincating bath is from about 20 to about 65° C.

It is a further object of the invention to provide a process wherein the zincating bath comprises zinc cations in an amount of 3 to 20 g/l; fluoride anions are present in an amount that is equal to or greater than the stoichiometric amount required to make ZnF₂ with said zinc cations; and the carboxylic acid is present in an amount such that the ratio of carboxylic acid to zinc cations is between 1:2 and 1:3.

It is a further object of the invention to provide a process wherein the autodeposition bath comprises an organic component selected from polymers and copolymers of acrylic, polyvinyl chloride, epoxy, polyurethane and mixtures thereof. Preferably the autodeposition bath comprises an organic component comprising an epoxy-acrylic hybrid polymer.

### DETAILED DESCRIPTION OF THE INVENTION

Applicants have discovered a mildly acidic aqueous solution comprising zinc cations and fluoride anions, in the presence of an inorganic acid and a carboxylic acid, having higher solubility of zinc cations, useful for depositing a metallic zinc coating on aluminum surfaces, without the aggressive etching of metallic surfaces seen in strongly alkaline zincating baths. This mildly acidic zincating bath is useful in depositing a thin shielding layer of metallic zinc on aluminum surfaces prior to autodeposition coating.

The mild acidic nature of the zincating bath reduces the dissolution of zinc from galvanized substrates that are processed in the zincating bath, whereas commercial alkaline zincating baths tend to dissolve some of the galvanized substrate if simultaneously processed with aluminum alloys.

The aqueous acidic zincating of aluminum is believed to proceed according to the following equation, resulting in a thin layer of zinc metal on the aluminum surface:

Al+ZnF₂+HF→Al—Zn+AlF₃

As used herein, the term “zinc fluoride” embraces anhydrous zinc fluoride (ZnF₂) and zinc fluoride tetrahydrate (ZnF₂ 4H₂O), both of which have low solubility in water. All values of amounts and concentrations of zinc fluoride given herein will be expressed as amounts and concentrations of the tetrahydrate, ZnF₂4H₂O. Although zinc fluoride and HF are used in one embodiment of the bath, it is also possible to use other zinc-containing compounds, different acids and other sources of fluoride, which do not result in unacceptable levels of precipitation or interfere with the deposition of a uniform zinc metal coating on the substrate.

Suitable sources of zinc cations present in the bath include water soluble salts of zinc, such as by way of non-limiting example zinc fluoride, zinc sulfate, zinc chloride and the like, as well as acid soluble zinc compounds that do not interfere with metallic zinc deposition, such as zinc oxide. In a working zincating bath according to the invention, the concentration of zinc cations, as calculated from the amount of zinc added to the aqueous bath, in increasing order of preference, is at least 2.5, 3.0, 3.5, 4.0, 4.5, 5.0, or 5.5 g/l and independently, in increasing order of preference, is not more than 30, 20, 15, 10, 9.5, 9.0, 8.5, 8.0, 7.5, 7.0, 6.5, 6.0 g/l.

Suitable sources of fluoride anions include zinc fluoride and hydrofluoric acid, which are preferred, as well as more water-soluble salts of fluorine, such as by way of non-limiting example, sodium fluoride and potassium fluoride. In a working zincating bath according to the invention, the concentration of fluoride anions, as calculated from the amount of fluoride added to the aqueous bath from all sources is at least equal to the stoichiometric amount required to form ZnF₂ from all of the zinc present in the bath. Preferably the amount of fluoride ion present is, in increasing order of preference, at least 1.5, 2.0, 2.5, 3.0 or 3.5 g/l, and independently, in increasing order of preference, is not more than 20, 18, 16, 14, 12, 10, 9, 8, 7, 6, 5, or 4 g/l.

The inorganic acid useful in the zincating bath is selected from inorganic acids that etch aluminum, and do not unduly interfere with the deposition of metallic zinc from the zincating bath onto aluminum surfaces. Suitable inorganic acids include, sulfuric acid, sulfurous acid, hydrochloric acid, and hydrofluoric acid; the latter being preferred. The amount of inorganic acid added, if used, is an amount sufficient to improve etching of the aluminum surface during zincating, without unduly increasing the re-dissolution of metallic zinc that has deposited on the aluminum surface. Determining the correct amount is within the ability of one of ordinary skill in the art without undue experimentation.

In their investigations, Applicants found that the addition of certain water soluble carboxylic acids to the aqueous zincating bath increased the solubility of the zinc cations in the presence of fluoride anions, such that more zinc cations were available for deposition as metallic zinc. Surprisingly, although the amount of zinc cations in solution increased in the presence of the carboxylic acids, the rate of deposition of metallic zinc decreased. These carboxylic acids also provided a more uniform coating of metallic zinc.

Not all carboxylic acids provided these benefits, for example oxalic acid formed insoluble zinc oxalate. It is thus preferred that zincating baths according to the invention contain a carboxylic acid whose zinc salt is soluble in water. Desirably, the carboxylic acid has at least one additional —OH functional group, meaning an —OH group that is not part of the carboxyl moiety, in the molecule. Preferred embodiments comprise aliphatic carboxylic acids having from two to ten carbon atoms, most preferably three to six carbon atoms. Suitable examples of such carboxylic acids include formic acid, malic acid, acetic acid, lactic acid and gluconic acid.

In one embodiment, the carboxylic acid is selected from C1-C₁₀ mono-carboxylic acids. In a preferred embodiment, the carboxylic acid is selected from C₂-C₁₀ carboxylic acids having at least one additional —OH substituent. In a working zincating bath according to the invention, the concentration of carboxylic acid, as calculated from the amount of the acid added to the aqueous bath, in increasing order of preference, is at least 7, 8, 9, 10, 11, 12, 13, 14, 15 g/l and independently, in increasing order of preference, is not more than 50, 40, 30, 20, 18, 17 g/l.

In one embodiment, an aqueous zincating bath according to the invention comprises:
a) zinc cations
b) fluoride anions;
c) an inorganic acid, preferably HF;
d) a C₂-C₁₀ carboxylic acid having at least one additional —OH substituent; and
e) optionally, ferric sulfate.

Typical metal chelating compounds, organic acids, surfactant, and other additives to control the fluoride activity may be used to improve the deposition profile of zinc metal on aluminum.

Other advantages of the invention were observed by using this mildly acidic zincating bath for zincating aluminum. For example, other metal substrates such as steel and/or galvanized parts can be processed simultaneously with the aluminum without depositing zinc on these substrates or modifying these substrates chemically.

The metallic zinc layer has a selected thickness range and the processing parameters for the zincating process have been developed experimentally to achieve this selected thickness range. Specifically, the metallic zinc layer has a thickness selected to prevent exposure of the aluminum surface by dissolution of the zinc layer in the autodeposition bath, while being thin enough to provide a uniform, adherent shielding layer for deposition of the corrosion resistant autodeposition layer. Preferably, prior to contact with the autodeposition bath, the metallic zinc layer has a thickness, in increasing order of preference, that is at least 30, 35, 40, 45, 50, 55, 60 mg/ft² and independently, in increasing order of preference, is not more than 120, 115, 110, 100, 90, 80, 70 mg/ft².

In the process of the invention, degreasing or other preliminary treatment (of an aluminum article to be coated with zinc) may be carried out in a conventional manner before the article is dipped in a zinc fluoride bath to deposit zinc. The article having an aluminum surface to be treated may be in the form of sheet, plate, extruded section or preformed shape, such as a pressing. The process of the invention is applicable to articles fabricated of a wide range of aluminum alloys and commercial purity aluminum, as well as other metal substrates having a surface of aluminum or aluminum alloy, such as by way of example, 6111 aluminum, 6022 aluminum and aluminized ferriferous metals including aluminized steel.

The zincating bath, prepared in one embodiment by adding solid particulate zinc fluoride to water, is preferably maintained at a pH of about 3 to about 6. In some instances it is desirable to provide a small quantity of undissolved zinc fluoride in the bath so that the bath is maintained in essentially saturated condition, but it is unnecessary for undissolved zinc fluoride to be present in the bath. The undissolved solids content may be satisfactory as long as it does not affect adversely the uniformity of the deposition reaction and the adhesion of deposited zinc to the surface of aluminum. The undissolved zinc fluoride precipitate can be used as a source of zinc cations, which will then replace the zinc in solution as it is used during the deposition reaction. Zinc fluoride dissolved in the bath will then remain at or close to the saturated concentration at the bath temperature.

Coating of the surfaces of an aluminum article with zinc in accordance with the invention is effected by immersing the article in an aqueous zinc fluoride bath as described above. When an article having an aluminum surface is dipped in an aqueous zinc fluoride bath, the rate of zinc deposition is mainly controlled by the bath temperature, residence time and concentration of ZnF₂, HF and carboxylic acid. The pH of the bath is desirably between 3 and 6.5 at 25° C. In a preferred embodiment, the pH of the bath is at least in increasing order of preference, 3.0, 3.5, 4.0, 4.5 and is not more than, in increasing order of preference 6.5, 6, 5.5, 5.0. The selection of residence time and temperature are important to the uniformity, thickness and adherence of the zinc metal coating and the later applied autodeposition coating. A lumpy, non-uniform metallic zinc layer can result in poor adherence of the zinc and polymeric layers. Preferred residence times range from about 15 seconds to 4 minutes at temperatures of about 20 to 65° C. Preferably, the residence time is about 1-2 minutes and the temperature range is about 20 to 30° C.

After a desired amount of metallic zinc has been deposited on the aluminum surface, the article is removed from the zincating bath and rinsed with water. The article may be dried and stored for later manufacture or may be subjected to the next processing step of autodeposition coating.

Over the last few decades, various water-based coatings for metallic surfaces have been developed which are commonly referred to in the field as autodeposition coatings. Such coatings utilize dispersions of resins capable of forming a protective coating when cured. The coating typically is applied by immersing the metallic surface in a bath containing the resin dispersion, acid, and an oxidizing agent to form an adherent coating that is initially wet. The thickness of the coating can be affected, for example, by such factors as total solids, pH and oxidant or accelerator concentration. Further, the coating thickness is a function of the immersion time. The initial wet coating is sufficiently adherent to remain attached to the surface on which it is formed against the influence of normal gravity and, if desired, can be rinsed before being cured (i.e., converted to a dry, solid and even more adherent coating) by heating.

Commercially available autodeposition baths are suitable for use in coating the zincated aluminum surface, and other active metal portions of the metallic article; these autodeposition baths can be readily made and used by one of skill in the art by reference to the autodeposition literature. Desirably, the autodeposition bath comprises an organic component selected from polymers and copolymers of acrylic, polyvinyl chloride, epoxy, polyurethane and mixtures thereof. Preferred polymers and copolymers are epoxy; acrylic; polyvinyl chloride, particularly internally stabilized polyvinyl chloride; and mixtures thereof; most preferably an epoxy-acrylic hybrid.

This invention also provides an autodeposition bath composition comprising (a) at least one of the aforedescribed polymers, (b) at least one emulsifier, (c) at least one cross-linker, (d) at least one accelerator component such as acid, oxidizing agent and/or complexing agents, (e) optionally, at least one colorant, (f) optionally, at least one filler, (g) optionally, at least one coalescing agent, and (h) water.

To prepare a bath composition suitable for coating a metallic substrate by autodeposition, at least one of the aforedescribed polymers in aqueous emulsion or dispersion is combined with an autodeposition accelerator component which is capable of causing the dissolution of active metals (e.g., iron and zinc) from the surface of the metallic substrate in contact with the bath composition. Preferably, the amount of accelerator present is sufficient to dissolve at least about 0.020 gram equivalent weight of metal ions per hour per square decimeter of contacted surface at a temperature of 20° C. Preferably, the accelerator(s) are utilized in a concentration effective to impart to the bath composition an oxidation-reduction potential that is at least 100 millivolts more oxidizing than a standard hydrogen electrode. Such accelerators are well-known in the autodeposition coating field and include, for example, substances such as an acid, oxidizing agent, and/or complexing agent capable of causing the dissolution of active metals from active metal surfaces in contact with an autodeposition composition. The autodeposition accelerator component may be chosen from the group consisting of hydrofluoric acid and its salts, fluosilicic acid and its salts, fluotitanic acid and its salts, ferric ions, acetic acid, phosphoric acid, sulfuric acid, nitric acid, hydrogen peroxide, peroxy acids, citric acid and its salts, and tartaric acid and its salts. More preferably, the accelerator comprises: (a) a total amount of fluoride ions of at least 0.4 g/L, (b) an amount of dissolved trivalent iron atoms that is at least 0.003 g/L, (c) a source of hydrogen ions in an amount sufficient to impart to the autodeposition composition a pH that is at least 1.6 and not more than about 5, and, optionally, (d) hydrogen peroxide. Hydrofluoric acid is preferred as a source for both the fluoride ions as well as the proper pH. Ferric fluoride can supply both fluoride ions as well as dissolved trivalent iron. Accelerators comprised of HF and FeF₃ are especially preferred for use in the present invention.

In one embodiment, ferric cations, hydrofluoric acid, and hydrogen peroxide are all used to constitute the autodeposition accelerator component. In a working composition according to the invention, independently for each constituent: the concentration of ferric cations preferably is at least, with increasing preference in the order given, 0.5, 0.8 or 1.0 g/l and independently preferably is not more than, with increasing preference in the order given, 2.95, 2.90, 2.85, or 2.75 g/l; the concentration of fluorine in anions preferably is at least, with increasing preference in the order given, 0.5, 0.8, 1.0, 1.2, 1.4, 1.5, 1.55, or 1.60 g/l and independently is not more than, with increasing preference in the order given, 10, 7, 5, 4, or 3 g/l; and the amount of hydrogen peroxide added to the freshly prepared working composition is at least, with increasing preference in the order given, 0.05, 0.1, 0.2, 0.3, or 0.4 g/l and independently preferably is not more than, with increasing preference in the order given, 2.1, 1.8, 1.5, 1.2, 1.0, 0.9, or 0.8 g/l.

A dispersion or coating bath composition of the present invention may also contain a number of additional ingredients that are added before, during, or after the formation of the dispersion. Such additional ingredients include fillers, biocides, foam control agents, pigments and soluble colorants, and flow control or leveling agents. The compositions of these various components may be selected in accordance with the concentrations of corresponding components used in conventional epoxy resin-based autodeposition compositions, such as those described in U.S. Pat. Nos. 5,500,460, and 6,096,806.

Suitable flow control additives or leveling agents include, for example, the acrylic (polyacrylate) substances known in the coatings art, such as the products sold under the trademark MODAFLOW® by Solutia, as well as other leveling agents such as BYK-310 (from BYK-Chemie), PERENOL® F-60 (from Henkel), and FLUORAD® FC-430 (from 3M).

Pigments and soluble colorants may generally be selected for compositions according to this invention from materials established as satisfactory for similar uses. Examples of suitable materials include carbon black, phthalocyanine blue, phthalocyanine green, quinacridone red, hansa yellow, and/or benzidine yellow pigment, and the like.

The dispersions and coating compositions of the present invention can be applied in the conventional manner. For example, with respect to an autodeposition composition, ordinarily a metal surface is degreased and rinsed with water before applying the autodeposition composition. Conventional techniques for cleaning and degreasing the metal surface to be treated according to the invention can be used for the present invention. The rinsing with water can be performed by exposure to running water, but will ordinarily be performed by immersion for from 10 to 120 seconds, or preferably from 20 to 60 seconds, in water at ordinary ambient temperature.

Any method can be used for contacting a metal surface with the autodeposition composition of the present invention. Examples include immersion (e.g., dipping), spraying or roll coating, and the like. Immersion is usually preferred.

Also furnished by this invention is a method of coating the zincated aluminum surface of a metallic substrate comprising the steps of contacting said metallic substrate with the aforedescribed autodeposition bath composition for a sufficient time to cause the formation of a film of the dispersed adduct particles on a zincated aluminum surface of the metallic substrate, separating the metallic substrate from contact with the autodeposition bath composition, rinsing the metallic substrate, and heating the metallic substrate to coalesce and cure the film of the dispersed adduct particles adhered to said zincated aluminum surface.

Other than in the operating examples, or where otherwise indicated, all numbers expressing quantities of ingredients, reaction conditions, or defining ingredient parameters used herein are to be understood as modified in all instances by the term “about”. Unless otherwise indicated, all percentages are percent by weight.

The invention and its benefits may be further appreciated by consideration of the following, non-limiting, examples and comparison examples.

### EXAMPLES

### Example 1

As used in the examples, ZnF₂ will be understood by those of skill in the art to mean the commercially available zinc fluoride tetrahydrate. A zincating bath was made up containing:

TABLE 1
Bath A: Zincating Bath

| Substance | Amount (grams) |
|---|---|
| Zinc fluoride tetrahydrate | 12.00 |
| Ferric sulfate (50%) | 10.00 |
| HF | 0.15 |
| DI water | remainder |
| Total | 1525.00 |

An autodeposition bath was made up using AUTOPHORETIC® 915, commercially available from Henkel Corporation, according to the instructions provided in Technical Process Bulletin No. 237300, Revised: Sep. 7, 2006. The bath contained 6% solids and 0.6 g/l hydrogen peroxide. Panels of 5052H32, 6111T43, and 6022T43 aluminum alloys were treated according to the procedure of Table 2.

TABLE 2
Processing

| Processing step | Time (min.) |
|---|---|
| Spray cleaned with Ridoline 212 (10%) at 140° F. | 2.5 |
| Tap water rinsed | 1 |
| DI water rinsed | 1 |
| Contacted with Zincating Bath A | 2 |
| DI water rinsed | 1 |
| Contacted with AUTOPHORETIC ® 915 Bath | 1.5 |
| Tap water rinsed | 1 |
| Contacted with E-2 Reaction Rinse | 1 |
| Flash dried | 7 |
| Oven cured at 185° C. | 40 |

The autodeposition coated panels were observed to be pinhole free.

### Example 2

A zincating bath was made up containing:

TABLE 3
Bath B: Zincating Bath

| Substance | Amount (grams) |
|---|---|
| Zinc fluoride tetrahydrate | 15.00 |
| HF | 0.25 |
| DI water | remainder |
| Total | 1520.00 |

The pH of Bath B was 4.75.

Panels of Al-6022 and Al-6111 aluminum were treated according to the procedure of Table 2, except that after contact with the zincating bath, the panels were allowed to air dry. The dry panels were observed to be grey in color with a thin uniform coating. An adhesion test was performed on the panels by scribing a line on the surface, through the zinc coating down to the aluminum substrate. Transparent tape was pressed to the scribe and pulled off at a substantially 180 degree angle to the scribed surface of the panel. The Al-6111 panel appeared to have a more adherent zinc coating than the Al-6022. Both substrates provided good adhesion of the zinc coating with not much powdery zinc on the transparent tape.

### Example 3

An investigation was made regarding the effect of lactic acid on solubility of zinc fluoride in a zincating bath. The effect of lactic acid on solubility and on zincating of aluminum surfaces was tested. A zincating bath containing lactic acid and a control which did not contain lactic acid were made up according to Table 4.

TABLE 4
Bath C: Zincating Bath

| Substance (grams) | Control Bath | Bath C (Lactic acid) |
|---|---|---|
| ZnF₂ | 32.5 | 32.5 |
| Lactic acid (85 wt %) | 0 | 10 |
| DI water | 1300 | 1300 |
| Solubility | Poor < half dissolved | Almost all dissolved |

The baths were stirred for 30 minutes and then observed. The control bath was cloudy and had crystal precipitate in the bottom. The bath containing lactic acid was clear and the zinc fluoride was almost completely dissolved. An additional 6.5 g of ZnF₂ was added to Bath C to bring the concentration of ZnF₂ to 30 g/l. Bath C was allowed to mix for 90 minutes and upon inspection the bath was clear and all crystals completely dissolved. A second dose of 6.5 g of ZnF₂ was added to Bath C to bring the concentration of ZnF₂ to 35 g/l, after 30 minutes mixing about 25% of the second dose remained undissolved. Bath C was decanted leaving the undissolved crystals in the container in about 100 ml of undecanted solution. 100 ml of water were added to the container and the crystals dissolved. The 200 ml solution was returned to Bath C making a total of 1.5 liters. The solubility of ZnF₂ in this 1.5 liter bath containing 10 g lactic acid was between 30 and 35 g/l. An additional 5 g of lactic acid were added to Bath C and upon inspection all crystals were completely dissolved and the solution was clear.

### Example 4

Three different acidic zincating baths containing ZnF₂, with added HF, were made to assess metallic zinc coating weight with two concentrations of lactic acid and without lactic acid being present. The control containing no lactic acid is identified as Bath # 1. After the baths were made, a reading of free fluoride ions activity as measured by a Lineguard® 101 Meter (commercially available from Henkel Corporation) and associated free fluoride sensitive electrode (commercially available from Orion Instruments) was made.
Bath #1: 15 g ZnF₂, 0.38 g HF to volume of 1500 mL. (1% ZnF₂, 0.25 g/L HF, Lineguard® 101 reading: 170 uA)
Bath #2: 15 g ZnF₂, 0.38 g HF, 7.5 g lactic acid to volume of 1500 mL. (1% ZnF₂, 0.25 g/L HF, 5 g/L lactic acid, Lineguard® 101 reading: 370 uA)
Bath #3: 30 g ZnF₂, 0.38 g HF, 7.5 g lactic acid to volume of 1500 mL. (2% ZnF₂, 0.25 g/L HF, 5 g/L lactic acid, Lineguard® 101 reading: 450 uA)

Comparing Bath #1 to Bath #2 shows that increasing the lactic acid concentration while holding the amount of ZnF₂ and HF added to the bath as constants resulted in a marked increase the Lineguard® 101 reading, indicating an increase in free fluoride ion.

Panels of two different types of aluminum alloy, 6022 and 611 were coated with metallic zinc by contact with the acidic zincating baths. Coating weights were measured with a 2 minute coat time for Baths #1, #2, and #3. The results are shown in Tables 5 and 6.

TABLE 5

| 6022 Aluminum | Bath #1 | Bath #2 | Bath #3 |
|---|---|---|---|
| Ct Wt 1 | 114 mg/ft² | 108 mg/ft² | 168 mg/ft² |
| Ct Wt 2 | 132 mg/ft² | 102 mg/ft² | 162 mg/ft² |
| Avg. Ct Wt | 123 mg/ft² | 105 mg/ft² | 165 mg/ft² |

TABLE 6

| 6111 Aluminum | Bath #1 | Bath #2 | Bath #3 |
|---|---|---|---|
| Ct Wt | 114 mg/ft² | 54 mg/ft² | 84 mg/ft² |

Although the lactic acid slowed zinc deposition, the increased concentration of ZnF₂ that the presence of lactic acid allows makes a thicker metallic zinc coating faster. All panels zincated in Table 6 were susceptible to coating removal in adherence testing using transparent tape removed from the coated panel surface at a 90° angle from the surface. Baking a panel at 185° C. did not eliminate metallic zinc coating loss. The adhesion strength of the metallic zinc coating did not negatively impact adhesion of the subsequently applied autodeposition polymeric coating as long as the zinc coating was not too thick.

### Example 5

Too much lactic acid stops the deposition of metallic zinc on aluminum surfaces; however the presence of lactic acid was found to increase the solubility of zinc fluoride and provides a more uniform and smooth coating layer. To identify a range for the concentration of lactic acid, a number of small zincating baths were made at a constant amount of 1 wt % ZnF₂ 4H₂O and 0.025 wt % HF with varying levels of lactic acid, as shown in Table 7. Small aluminum panels, alloy 6111, were cleaned with Ridoline 212 then rinsed for 1 minute in tap water then 1 minute in DI water. All were coated in zincating bath for 2 minutes. After all were zincated, the panels were dried with an air hose and then visually compared to one another.

TABLE 7

| Bath | Lactic Acid (g) | Observations on metallic zinc coating |
|---|---|---|
| 5-1 | 0.1 | produced a good zinc layer that would coat well in an |
| | | autodeposition bath |
| 5-2 | 0.3 | produced a good zinc layer that would coat well in an |
| | | autodeposition bath |
| 5-3 | 0.5 | had a thinner zinc coating but will provide a suitable |
| | | autodeposition coating |
| 5-4 | 0.7 | had a thinner zinc coating but will provide a suitable |
| | | autodeposition coating |
| 5-5 | 1.0 | zinc layer is very thin and while it may coat without pinholes, it |
| | | would produce a very thin autodeposition coating |
| 5-6 | 1.5 | more of a color change from the etching than an actual layer |
| | | of zinc deposited, would not autodeposition coat sufficiently |
| 5-7 | 2.5 | more of a color change from the etching than an actual layer |
| | | of zinc deposited, would not autodeposition coat sufficiently |
| 5-8 | 3.5 | more of a color change from the etching than an actual layer |
| | | of zinc deposited, would not autodeposition coat sufficiently |
| 5-9 | 5 | more of a color change from the etching than an actual layer |
| | | of zinc deposited, would not autodeposition coat sufficiently |

Coating weights were measured on Aluminum alloy 6111 panels zincated for 2 minutes in the following solutions:
1% Zn bath with 3 g/L of lactic acid: 42 mg/ft².
1% Zn bath with 7 g/L of lactic acid: 30 mg/ft².
1% Zn bath with 15 g/L of lactic acid: 24 mg/ft².

### Example 6

The solubility limits of ZnF₂ in an aqueous solution of lactic acid were explored. The results are shown in Table 8.

TABLE 8

| Lactic | | | Solubility | |
|---|---|---|---|---|
| Acid | ZnF₂ | Ratio | of | Metallic zinc |
| (g/l) | (g/l) | Lactic Acid:ZnF₂ | ZnF₂ | coating weight |
| 10 | 30 | 1:3 | Soluble | 90 mg/ft² |
| 10 | 40 | 1:4 | Nonsoluble | — |
| 15 | 40 | 1:2.67 | Nonsoluble | — |
| 20 | 40 | 1:2 | Soluble | 96 mg/ft² |
| 20 | 50 | 1:2.5 | Nonsoluble | — |
| 30 | 50 | 1:1.67 | Soluble | 102 mg/ft² |
| 30 | 60 | 1:2 | Nonsoluble | — |
| 40 | 60 | 1:1.5 | Nonsoluble | — |
| 50 | 60 | 1:1.2 | Soluble | 60 mg/ft² |

The starting ratio of lactic acid to ZnF₂ was 1:3. As additions of lactic acid were made to keep the increasing amount of ZnF₂ soluble, the ratio at which there was solubility changed. In the beginning, the increased amount of zinc made up for the slow deposition due to the increased lactic acid concentration. But as the lactic acid concentration became higher the ratio of 1:3 ratio or even a 1:2 ratio could not be maintained. The last coating weight measured with 5:6 ratio showed that the metallic zinc coating was becoming thinner.

### Example 7

The effect of temperature on the aqueous acidic zincating bath was explored. A 1% ZnF₂ bath containing 5 g/L of lactic acid and 0.25 g/L of HF was heated to about 65° C. A panel of Aluminum 6111 was zincated in the bath for 2 minutes. This produced a very thick zinc layer that was lumpy and very loose. Another panel was zincated for 30 seconds and provided a metallic zinc coating thickness that was more acceptable for deposition of an autodeposited coating. The 30 second coating was a little uneven due to the higher rate of deposition. The faster deposition does not appear to increase zinc layer adhesion strength.

### Example 8

An alternative to lactic acid was used to make a zincating bath. A 1% ZnF₂ bath with 0.25 g/L of HF and 5 g/L of gluconic acid was made. The ZnF₂ went into solution quickly. Panels of 6111 aluminum were zincated for 2 minutes. There was a very thin layer of deposition of metallic zinc on the panel. The solution of gluconic acid used was about 50%. The layer of zinc deposited was similar to a zincated panel in a bath containing a high level of lactic acid, around 15 g/L. Gluconic acid can be used in place of lactic acid to help increase zinc solubility and produce a smoother coating of zinc.

### Example 9

Panels of 6111 and 6022 aluminum alloy were coated according to the procedure of Table 2 using the zincating baths as shown in Table 9 in place of Zincating Bath A and AQUENCE™ 930, commercially available from Henkel Corporation, in place of Autophoretic 915. Cross hatch adhesion and mandrel bend testing were performed after coating the zincated aluminum alloys with the autodeposition coating and curing at 185° C. for 40 minutes. The test results are shown in Table 9.

TABLE 9

| | Aluminum | Cross-Hatch | Adhesion |
|---|---|---|---|
| Zincating Bath | Alloy | Test | after Mandrel Bend Test |
| 1 wt % ZnF₂ | 6111 | 100% | Good adhesion |
| | | retention | |
| 1 wt % ZnF₂ | 6111 | 100% | Good adhesion |
| 5 g/l lactic acid | | retention | |
| 2 wt % ZnF₂ | 6111 | 100% | Good adhesion |
| 5 g/l lactic acid | | retention | |
| 1 wt % ZnF₂ | 6022 | 100% | Good adhesion |
| | | retention | |
| 1 wt % ZnF₂ | 6022 | 100% | Good adhesion |
| 5 g/l lactic acid | | retention | |
| 2 wt % ZnF₂ | 6022 | 100% | No adhesion loss, |
| 5 g/l lactic acid | | retention | some small cracks along bend |

The 6022 aluminum alloy panel that had small cracks after the mandrel bend test appears to have a thicker zinc coating than the others. The paint surface is a little more textured than the others.

### Example 10

The aluminum panels of Example 9 were tested in for corrosion resistance in neutral salt spray according to ASTM B117. All the zincated aluminum panels showed creep below 1 mm after 504 hrs of salt fog exposure. There was no difference in neutral salt spray performance attributable to incorporating lactic acid in the zincating bath.

### Example 11

The effect of contacting substrates having a zinc or zinc/iron surface with acidic zincating baths was explored. An electrogalvanized steel panel was contacted with an aqueous acidic zincating bath containing 1% ZnF₂ 5 g/L of lactic acid and 0.25 g/L of HF. The metallic zinc coating weights on the panel are shown for various contact times in Table 10.

TABLE 10

| Treatment Time in Zincating Bath | 3 minutes | 2 minutes | 1 minute |
|---|---|---|---|
| Panel Weight After Zincating | 93.668 | 93.224 | 94.148 |
| Weight of Panel Prior To Zincating | 93.668 | 93.228 | 94.152 |
| Weight of Zinc Deposited | 0 | −0.004 | −0.004 |

Zinc was not deposited on the electrogalvanized surfaces, nor does it appear to have deposited on the cut edges of the panel where steel was exposed.

What is claimed is:

1. An aqueous acidic zincating bath comprising:
a) At least 50 wt % water;
b) zinc cations;
c) fluoride anions;
d) a carboxylic acid capable of forming a water soluble zinc salt; and
e) optionally, ferric sulfate.

2. The aqueous acidic zincating bath of claim 1, further comprising an inorganic acid and the zincating bath has a pH of about 3 to about 6.5.

3. The aqueous acidic zincating bath of claim 1, wherein the carboxylic acid has at least one additional —OH substituent.

4. The aqueous acidic zincating bath of claim 1, wherein the carboxylic acid is selected from the group of aliphatic mono-carboxylic acids having from one to ten carbon atoms.

5. The aqueous acidic zincating bath of claim 1, wherein the carboxylic acid is selected from the group of aliphatic carboxylic acids having from two to ten carbon atoms and at least one addition —OH substituent.

6. The aqueous acidic zincating bath of claim 1, wherein:
zinc cations are present in an amount of 3 to 20 g/l;
fluoride anions are present in an amount that is equal to or greater than the stoichiometric amount required to make ZnF₂ with said zinc cations; and
the carboxylic acid is present in an amount such that the ratio of carboxylic acid to zinc cations is between 1:2 and 1:3.

7. A process for coating an article comprising a substrate having at least one aluminum surface comprising:
a) depositing a metallic zinc coating on the aluminum surface by contacting the aluminum surface with the zincating bath of claim 1;
b) rinsing with water;
c) contacting the metallic zinc coated aluminum surface with an autodeposition bath, for a sufficient time and at a sufficient temperature to deposit an uncured autodeposition coating thereon;
d) rinsing with water;
e) optionally, contacting the uncured autodeposition coating with an alkaline or acidic rinse;
f) curing the uncured autodeposition coating.

8. The process of claim 7, wherein the metallic zinc coating deposited has a thickness of about 30 to about 120 mg/ft².

9. The process of claim 7, wherein the temperature of the zincating bath is from about 20 to about 65° C.

10. The process of claim 7, wherein the zincating bath comprises
zinc cations in an amount of 3 to 20 g/l;
fluoride anions are present in an amount that is equal to or greater than the stoichiometric amount required to make ZnF₂ with said zinc cations; and
the carboxylic acid is present in an amount such that the ratio of carboxylic acid to zinc cations is between 1:2 and 1:3.

11. The process of claim 7, wherein the autodeposition bath comprises an organic component selected from polymers and copolymers of acrylic, polyvinyl chloride, epoxy, polyurethane and mixtures thereof.

12. The process of claim 7, wherein the autodeposition bath comprises an organic component comprising an epoxy-acrylic hybrid polymer.

13. An article of manufacture comprising: (a) a substrate comprising aluminum or an aluminum alloy; (b) a shielding layer provided on the substrate, the shielding layer comprising metallic zinc; and (c) a corrosion resistant layer on the shielding layer, the corrosion resistant layer comprising an autodeposited coating.

14. The article of manufacture of claim 13, wherein the autodeposited coating comprises an organic component selected from polymers and copolymers of acrylic, polyvinyl chloride, epoxy, polyurethane and mixtures thereof.

15. The article of manufacture of claim 14, wherein the autodeposited coating comprises an organic component comprising an epoxy-acrylic hybrid polymer.

16. An article of manufacture according to claim 13, wherein the substrate comprises an outer clad layer formed of aluminum or an aluminum alloy and an inner core layer, and wherein the shielding layer is disposed on the clad layer.

17. An article of manufacture according to claim 16, wherein the clad layer comprises an aluminum alloy containing aluminum and one or more alloying elements selected from silicon, magnesium, zinc and manganese.

18. An article of manufacture comprising: (a) a substrate comprising an aluminum or aluminum alloy surface; (b) a shielding layer provided on the aluminum or aluminum alloy surface, the shielding layer comprising metallic zinc; and (c) a corrosion resistant layer on the shielding layer, the corrosion resistant layer comprising an autodeposited coating.

19. The article of manufacture of claim 18, wherein the autodeposited coating comprises an organic component selected from polymers and copolymers of acrylic, polyvinyl chloride, epoxy, polyurethane and mixtures thereof.
